(19) United States
(12) Patent Application Publication
(10) Pub. No.: US 2004/0168197 A1
(43) Pub. Date: Aug. 26, 2004

(54) Method and apparatus for transmitting module information representing application resource in data carousel scenario of DASE data broadcasting system

(75) Inventors: Kwang-Hyun Koh, Seoul (KR); Kwang-Kee Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/705,831

(22) Filed: Nov. 13, 2003

(30) Foreign Application Priority Data
Nov. 14, 2002 (KR) 2002-70754

(51) Int. Cl. H04N 7/173; H04N 7/16; H04N 7/00; H04N 11/00

(52) U.S. Cl. 725/112; 725/113; 725/109; 725/135; 348/461

(57) ABSTRACT

Provided are a method and apparatus for transmitting module reference information representing application resources in a data carousel scenario of a DASE data broadcasting system. The method includes inserting uniform resource identifier (URI) information into a DownloadServerInitiate (DSI) message that provides information regarding a module group, the module group having a predetermined number of modules and the URI information being shared by modules belonging to the module group, and inserting the remaining URI information, except for the shared URI information, into a DownloadInfoIndication (DII) message that provides the module information. Accordingly, it is possible to save space in a DII message and consequently insert more modules into the DII message.

### BACKGROUND OF THE INVENTION

This application claims the priority of Korean Patent Application No. 10-2002-0070754 filed Nov. 14, 2002, in the Korean Intellectual Property Office, the disclosure of which is incorporated herein in its entirety by reference.

1. Field of the Invention

The present invention relates to a method and apparatus for transmitting module reference information representing application resources in a data carousel scenario of a DTV application software environment (DASE) data broadcasting system.

2. Description of the Related Art

Advances in digital television (DTV) broadcasting systems make it possible to send an increased amount of additional information to television viewers and results in further development of standards for data broadcasting, enabling television viewers to conduct electronic commercial transactions (T-Commerce) through the use of television. International standards for data broadcasting include DTV Application Software Environment (DASE) Standards which are provided by the Advanced Television Systems Committee (ATSC), Multimedia Home Platform (MHP) Standards provided by Digital Video Broadcasting (DVB), and OpenCable Applications Platform (OCAP) Specifications. Through use of the DASE standards, domestic terrestrial broadcasters have televised the 2002 FIFA World Cup and 2002 Asian Games; they are currently broadcasting trial services.

The ATSC published DASE-1 as an international data broadcast standard on September of 2002 and revised ATSC Data Broadcast Standard A/90 and ATSC Data Application Reference Model A/94. As a result, domestic broadcasters are currently making amendments to data broadcast standards based on the DASE-1 and the above revisions. According to the amendments, information including a multipart descriptor, a multiple identifier structure, and a multiple content-type structure, is deleted from a data service table (DST) and then included in a DownloadInfoIndication (DII) message, a control message of the Digital Storage Medium Command and Control (DSM-CC) User-to-Network download protocol.

As shown in FIG. 1, the DASE Standards have a hierarchical relationship 100 with other standards 110, 120, 130, 140, 150, 160, 170 and 180 provided by the ATSC. Referring to FIG. 1, a DASE application 190 can be transmitted using various types of protocols provided by the subordinate data services shown in FIG. 1. The available protocols are specified in a protocol-encapsulation field included in the DST (for details, see ATSC documents A/90 and A/91). If the field contains a value of 0×0 D, the DASE application 190 is transmitted using an asynchronous carousel scenario of the DSM-CC download protocol, i.e., data carousel transmission.

Using data carousel protocol, the limited amount of data contained in a data carousel 200 is periodically and repeatedly transmitted, as shown in FIG. 2. Declarative applications and procedural applications are delivered using the data carousel protocol. The declarative application is a DASE application whose initial entity is the specific markup of application/xhtml+xml. The procedural application is a DASE application whose entity is the specific active object content-type of application/javatv−xlet. Each of the files for these applications consists of a module and each module is divided into units of a DownloadDataBlock (DDB) message.

When the DDB is transmitted using data carousel protocol, a DII message is created to provide module and DDB control information to a receiving side. However, all modules may not be included in a DII message. This can occur when the number of modules is larger than a predetermined number or several module groups are created for easy management. In the latter case, the modules are divided into several module groups and numerous DII messages containing module group information are created. A DownloadServerInitiate (DSI) message is then generated, containing control information regarding the DII messages and used to transmit the DII messages to the receiving side.

FIG. 3 illustrates an example of the control information structure that is transmitted in a 2-layer structure when delivering module information using conventional data carousel transmission. Referring to FIG. 3, a DSI message 310 describes group information using GroupInfoByte fields gi 311 and gi 312. The field gi 311 relates to the first DII message 320 and the field gi 312 relates to the second DII message 360. The first DII message 320 describes the modules in the download scenario using the ModuleInfoByte field mi 330, second ModuleInfoByte field mi 340, and third ModuleInfoByte field mi 350. The first ModuleInfoByte field mi 330 contains information on DDBs 331 through 334, the second ModuleInfoByte field mi 340 contains information on DDBs 341 and 342, and the third ModuleInfoByte field mi 350 contains information on DDBs 351 through 353. Similarly, the second DII message 360 includes the fourth ModuleInfoByte field mi 370, fifth ModuleInfoByte field mi 380, and sixth ModuleInfoByte field mi 390. The ModuleInfoByte field mi 370 contains information on DDBs 371 and 372, the ModuleInfoByte field mi 380 contains information on DDBs 381 through 384, and the ModuleInfoByte field mi 390 contains information on DDBs 391 through 393. DDBs, which correspond to one ModuleInfoByte field mi, constitute a module. Modules, which correspond to one DII message, constitute a module group. Module groups, which correspond to one DSI message, constitute a super module group.

The two-layer data carousel 200 having two module groups will now be described with reference to FIG. 2.

Referring to FIG. 2, a DSI message 210 contains information regarding first and second module groups G1 and G2. A DII message 220 contains information regarding modules M1, M2, and M3, which are included in the first module group G1. A DII message 230 contains information regarding modules M4 and MS, which are included in the second module group G2. The modules M1, M2, M3, M4, and MS form files file 1, file 2, file 3, file 4, and file 5, respectively. The module M1 includes DDBs M1-0 221, M1-1 222, and M1-2 223. The module M2 includes DDBs M2-0 224 and M2-1 225. The module M3 includes DDBs M3-0 226, M3-1 227, M3-2 228, and M3-3 229. The module M4 includes DDBs M4-0 231, M4-1 232, and M4-2 233. The module MS includes DDBs M5-0 234, MS-1 235, MS-2 236, and MS-3 237. The information mentioned above in the data carousel 200 is periodically transmitted.

As shown in FIG. 1, the Application Reference Model (ARM) 180, an ATSC standard subordinate to the DASE application 190, provides information about the environment of the DASE application 190 to a receiving side. Information provided by the ARM 180 includes information including an application model, identification and naming, data encapsulation, descriptors, announcement, and signaling.

Based on the revision of the ATSC standard, a descriptor needs to be amended in a current trial airing stream. In order to disclose the paths and names of files, identifiers and content-type must be provided to the receiving side. The previous ARM standard addresses this by specifying that identifiers and content-type are inserted into the DST using a multipart descriptor, a multiple identifier structure, and a multiple content-type structure. The DST is then transmitted to the receiving side. However, in the latest ARM standard, the definitions of the above descriptors are not included in the DST, and thus, it is impossible to send the identifiers and content-type to the receiving side utilizing the DST. Instead, the file paths, files names, and information regarding content-type are provided to the receiving side through a DII message. A uniform resource identifier (URI) descriptor and a content-type descriptor are inserted into the module group information of a DII message.

This change in ARM binding information has resulted in a reduction in size of the DST and an increase in size of the DII message. However, because a DII message must consist of such an information section, the number of modules that can be included in the DII message decreases. The division of a module group requires a group link descriptor to ensure information is contained in several DII messages. Accordingly, it is very complicated and difficult to transmit files in a DASE system using a data carousel protocol.

In order to include more module information in a DII message, information regarding the file paths, file names, and content-type needs to be reduced.

### SUMMARY OF THE INVENTION

The present invention provides a method and apparatus for transmitting as much module information as possible and saving space in a DII message in the data carousel scenario of a DTV application software environment (DASE) data broadcasting system.

According to an illustrative, non-limiting embodiment of the present invention, information regarding a common uniform resource identifier (URI) and content-type is included in a GroupInfoByte field of a DownloadServerInitiate (DSI) message. Additionally, information is included in a DownloadInfoIndication (DII) message.

According to an exemplary aspect of the present invention, there is provided a method of transmitting first module information representing application resources in a DASE data broadcasting system using a data carousel protocol, the method comprising inserting uniform resource identifier (URI) information into a DownloadServerInitiate (DSI) message that provides information regarding a module group, the module group having a predetermined number of modules and the URI information being shared by modules belonging to the module group, and inserting the remaining URI information, except for the shared URI information, into a DownloadInfoIndication (DII) message that provides the first module information.

According to another exemplary aspect of the present invention, there is provided a method of transmitting second module information representing application resources in a DASE broadcasting system using a data carousel protocol, the method comprising inserting content-type information into a DSI message that provides information regarding a module group, the module group having a predetermined number of modules and the content-type information being shared by modules belonging to the module group, and inserting the remaining content-type information, except for the shared content-type information, into a DII message that provides the second module information.

According to yet another exemplary aspect of the present invention, there is provided an apparatus for transmitting module information representing application resources in a DASE data broadcasting system using a data carousel protocol, the apparatus comprising a message creator which creates a DSI message and a DII message, the DSI message providing information regarding module groups and containing URI information shared by modules belonging to the module groups, each module group having a predetermined number of modules, and the DII message providing module information and containing the remaining URI information except for the shared URI information, and a message sender which sends the created messages.

According to still another exemplary aspect of the present invention, there is provided an apparatus for transmitting module information representing application resources in a DASE data broadcasting system using a data carousel protocol, the apparatus comprising a message creator which creates a DSI message and a DII message, the DSI message providing information regarding module groups and containing content-type information shared by the modules belonging to the module groups, each module group having a predetermined number of modules, and the DII message providing module information and containing the remaining content-type information except for the shared content-type information, and a message sender which sends the created messages.

### BRIEF DESCRIPTION OF THE DRAWINGS

The above and other exemplary aspects and advantages of the present invention will become more apparent by describing in detail illustrative embodiments thereof with reference to the attached drawings in which:

FIG. 1 is a block diagram illustrating the hierarchical relationship of a DTV Application Software Environment (DASE) Standard among the other standards provided by the Advanced Television Systems Committee (ATSC);

FIG. 2 is a block diagram illustrating conventional data carousel transmission;

FIG. 3 is a block diagram of the control information structure that is transmitted in a two-layer structure when delivering module information using conventional data carousel transmission;

FIG. 4 is a block diagram illustrating transmission of application resource information using a DownloadServerInitiate (DSI) message and a DownloadInfoIndication (DII) message, according to an illustrative embodiment of the present invention;

FIG. 5 illustrates a field that contains information shared by application resources in the DSI message shown in FIG. 4;

FIG. 6 illustrates a field that contains information that is not shared by application resources in the DII message of FIG. 4;

FIG. 7 illustrates a DSI message and a DII message, which contain uniform resource identifier (URI) information about an application resource, according to another embodiment of the present invention;

FIG. 8 illustrates a DSI message and a DII message, which contain content-type information regarding an application resource, according to a further embodiment of the present invention;

FIG. 9 is a block diagram of the structure of a module information transmitting apparatus according to yet another embodiment of the present invention;

FIG. 10 illustrates the test streams used during a method of application resource transmission according to still another embodiment of the present invention;

FIG. 11 illustrates the total size of descriptors transmitted using a method of application resource transmission, according to another embodiment of the present invention;

FIG. 12 illustrates the average size of descriptors transmitted using a method of application resource transmission, according to a further embodiment of the present invention; and

FIG. 13 is a graph illustrating the maximum number of modules that can be inserted into a DII message, according to yet another embodiment of the present invention.

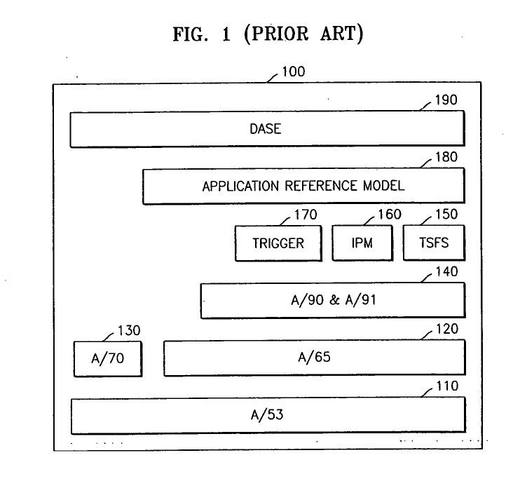

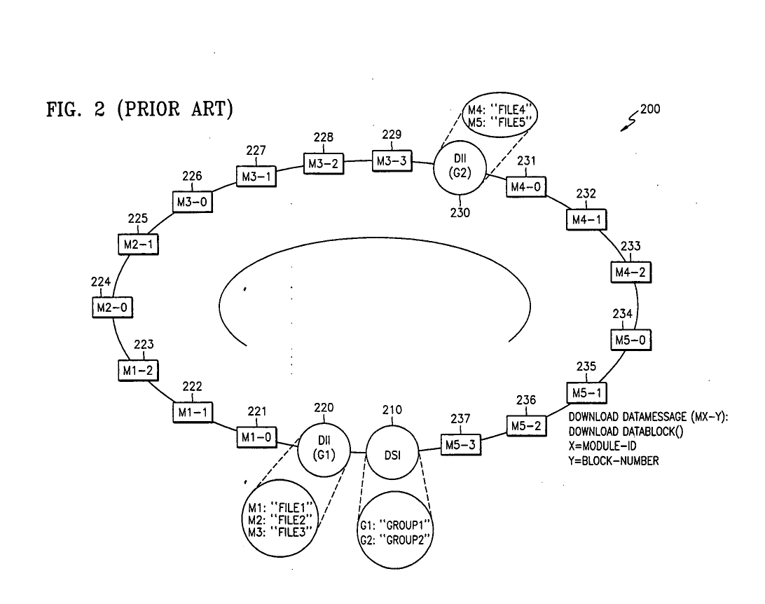

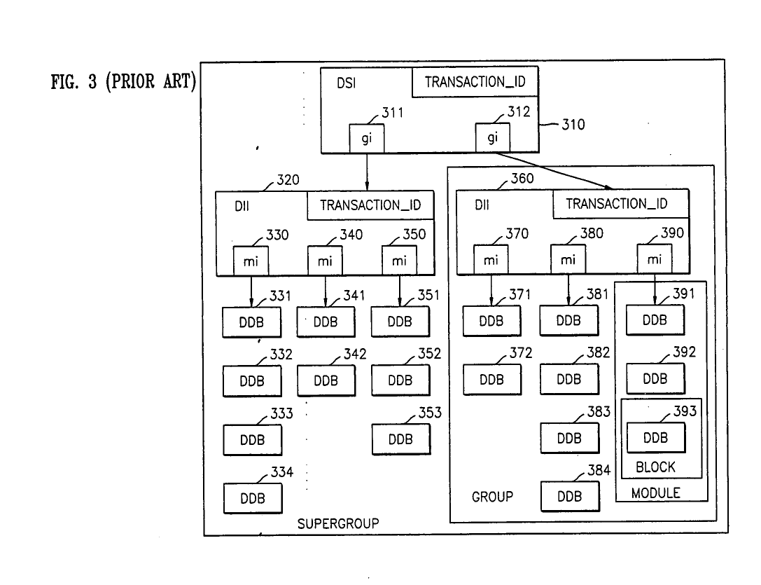

### DETAILED DESCRIPTION OF THE INVENTION

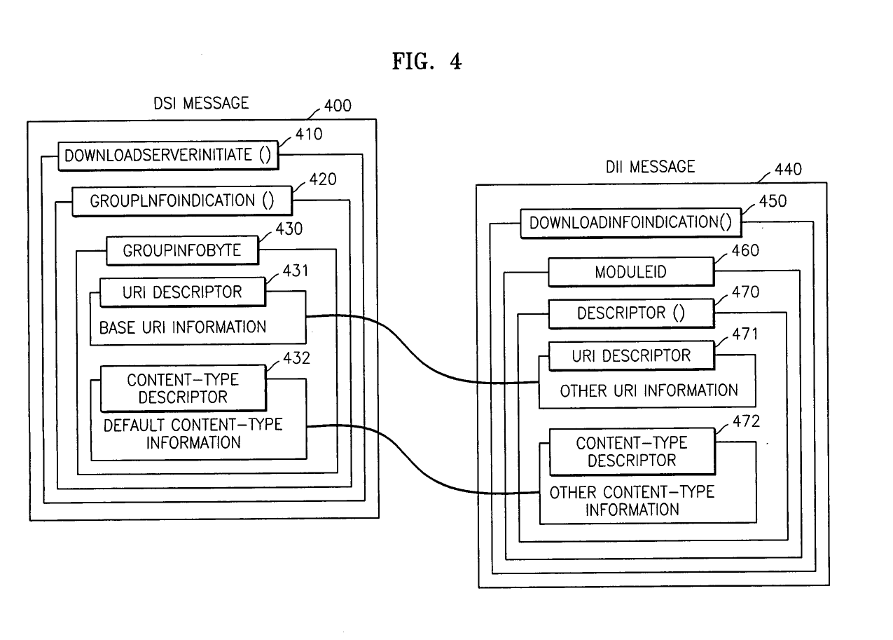

With reference to FIG. 4, a method of transmitting application resources represented by module information and using a DownloadServerInitiate (DSI) message 400 and a DownloadInfoIndication (DII) message 440, will now be described.

The DSI message 400 includes a structure downloadServerInitiate() 410. The structure downloadServerInitiate() 410 includes a structure groupInfoIndication() 420 which includes a field groupInfoByte 430.

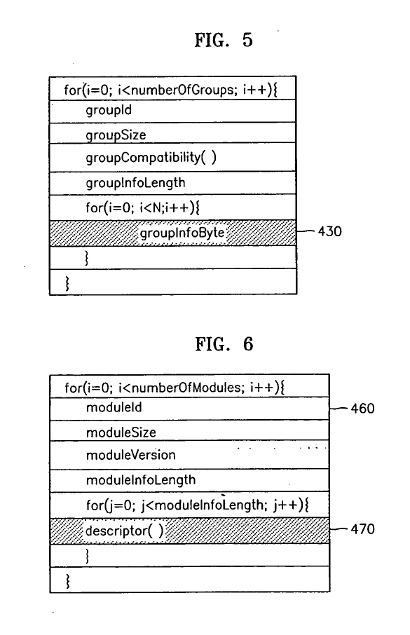

Detailed information contained in the structure groupInfoIndication() 420 is illustrated in FIG. 5 and constitutes the module group information contained in the DSI message 400. As shown in FIG. 5, group information is comprised of an ID field groupId, a size field groupsize, a compatibility structure groupcompatibility(), a group information length field groupInfoLength, and a group information field groupInfoByte 430. The field groupInfoByte 430 may include a descriptor that defines the attributes of the group.

A structure field downloadInfoIndication() 450 contained in the DII message 440 includes the field moduleld 460 and the structure descriptor() 470. The structure descriptors 470 provides additional information regarding a module.

The information regarding the structure downloadInfoIndication() 450 is illustrated in FIG. 6 and constitutes the module information contained in the DII message 440. As shown in FIG. 6, module information is comprised of an id field moduleId, a size field moduleSize, a version field moduleVersion, a module information length field moduleInfoLength, and a module information structure descriptor() 470.

The field groupInfoByte 430 of the DSI message 400 includes a uniform resource identifier (URI) descriptor 431 and a content-type descriptor 432. The URI descriptor 431 contains base URI information shared by modules belonging to the same module group, and the content-type descriptor 432 contains default content-type information that is most frequently shared by the modules. The structure descriptors 470 of the DII message 440 also includes a URI descriptor 471 and a content-type descriptor 472. The URI descriptor 471 contains URI module information, excluding base URI information shared by modules belonging to the same module group. When a target module is of default content type, the content-type descriptor 472 is left blank. Otherwise, the content-type descriptor 472 is defined.

Files belonging to the same module group are more likely to be located in the same path. Accordingly, the path names to which a plurality of files belong are included in the DSI message 400, while other paths are included in the DII message 440. Therefore, the names of shared paths are not unnecessarily repeatedly described in the DII message 440, resulting in saved space in the DII message. In addition, a plurality of files of the same content type, such as image files, may be included in the same module group. The file content-type appearing the most frequently in the same module group is described as the default content type in the DSI message. In the DII message, modules of the default content type are described without a content-type descriptor, while other modules are described with related content-type descriptors, also resulting in saved space in the DII message.

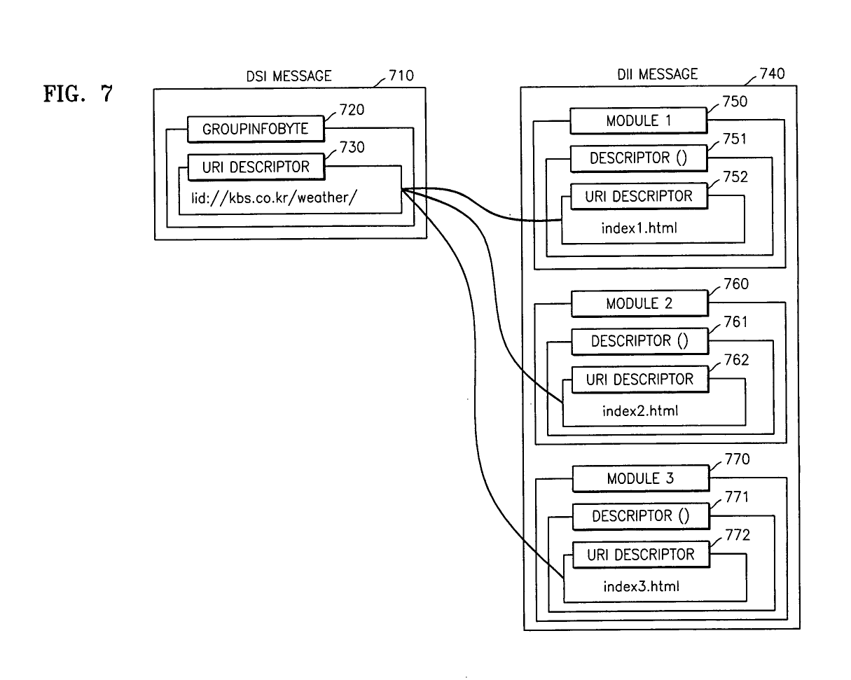

An example of a DSI message containing a common URI descriptor is illustrated in FIG. 7. Let us assume that a particular group includes first, second and third modules 750, 760 and 770, respectively, having URIs as described below.

A URI lid://kbs.co.kr/weather/ is commonly described in the URIs of the first through third modules. The common URI reading lid://kbs.co.kr/weather/ is described in a URI descriptor 730 in the DSI message 710. The remaining URIs are described in URI descriptors 752, 762, and 772 included in the DII message 740. More specifically, index1.html is described in the URI descriptor 752 of the first module 750, index2.html is described in the URI descriptor 762 of the second module 760, and index3.html is described in the URI descriptor 772 of the third module 770.

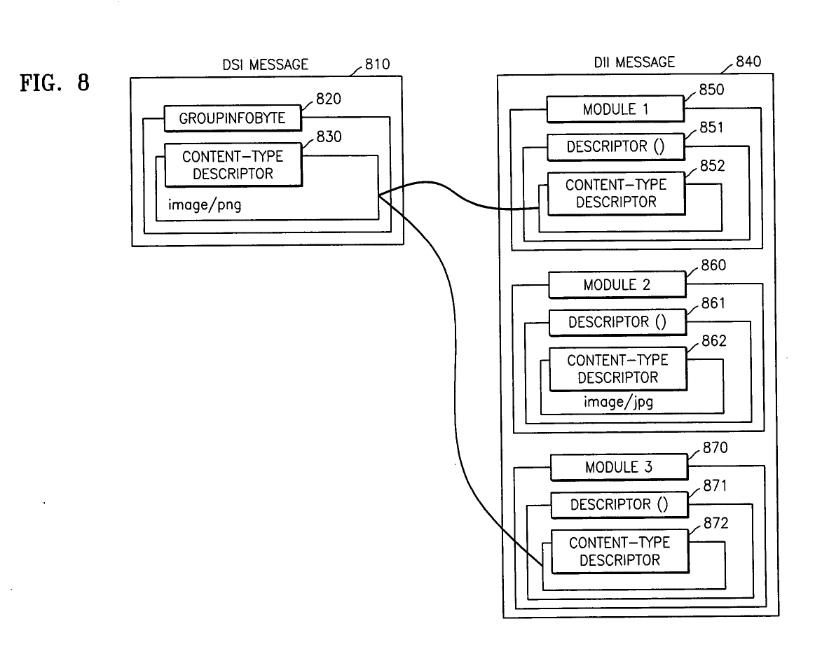

An example of a DSI message 810 containing a common content-type descriptor is illustrated in FIG. 8. Let us assume that the content type of the first module 850 is “image/png”, the content type of the second module 860 is ‘image/jpg’, and the content type of the third module 870 is “image/png”. In this case, image/png, which occurs most frequently and thus is the common content-type, is described as the default content type in a content-type descriptor 830 of the DSI message 810. The content types of modules not identified as the default are described in a DII message 840. As FIG. 8 illustrates, the content-type descriptors 852 and 872 of the first and third modules 850 and 870 are left blank, while a content-type descriptor 862 of the second module 860 is described by “image/jpg”.

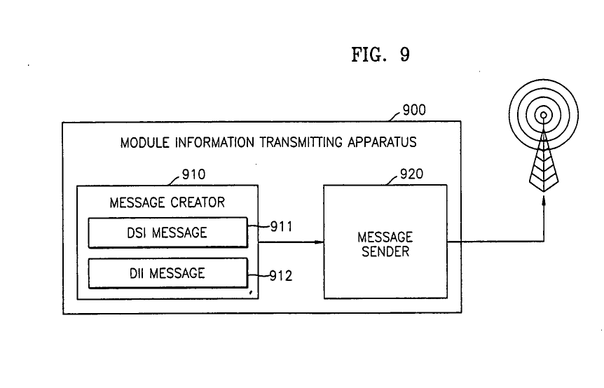

FIG. 9 is a block diagram of a module information transmitting apparatus 900 according to an illustrative embodiment of the present invention. The apparatus 900 enables the aforementioned module information transmission using a DSI message containing shared information and a DII message containing the remaining information, to be easily performed. Referring to FIG. 9, the apparatus 900 includes a message creator 910 which creates a DSI message 911 and a DII message 912, and a message sender 920 that transmits those messages generated by the message creator 910.

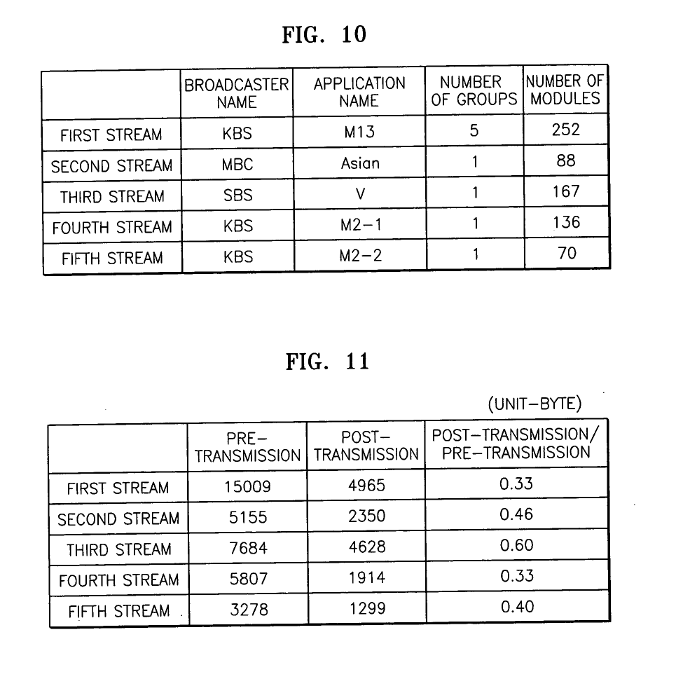

With reference to FIGS. 10 through 13, simulation results of a method of transmitting module information using DSI and DII messages, according to an illustrative embodiment of the present invention, will be described.

FIG. 10 illustrates the names of domestic terrestrial broadcasters, application names, number of module groups, and number of modules with respect to test streams. In the simulation, an STB (K-0150i) setup box manufactured by Samsung Electronics, Co., Ltd., was used to receive and test streams of trial broadcasting services. The streams were transmitted from domestic terrestrial broadcasters KBS, MBC, and SBS during the 2002 Asian Games. The first and third streams provided virtual channel services unrelated to the main programming, such as weather information, traffic information, and stock information. The second, fourth, and fifth streams provided enhanced services, such as the actual content of the 2002 Asian Games or other program related information.

FIG. 11 is a table illustrating changes in the amount of data and the number of modules, which are included in a DII message, before and after performing the method of transmitting module information according to an illustrative embodiment of the present invention. The table of FIG. 11 shows the sum of the sizes of URI descriptors and content-type descriptors included in an application, with respect to the first through fifth streams. After performing the method, the sum of descriptor sizes, is reduced to about 42% of the data amount prior to performing the method. However, the reduction ratio for the size of data in the third stream is smaller than in the other streams. This results from the short resource path names of the third stream and the small number of URIs shared by files. The outcome can also be attributed to the longer file name lengths in the third stream.

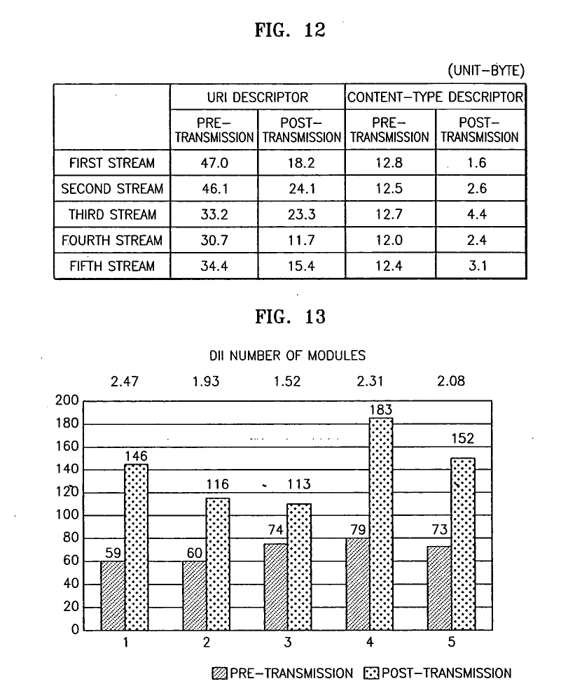

FIG. 12 illustrates variations in the average sizes of URI descriptors and content-type descriptors with respect to the first through fifth streams. Results are shown for before and after carrying out a method of transmission according to an illustrative embodiment of the present invention. The average sizes of the URI descriptors are about 38 bytes before transmission and about 18 bytes after transmission. These values indicate that it is possible to reduce the sizes of the URI descriptors by roughly 20 bytes using the method of transmission. In contrast, the average size of content-type descriptors is about 12 bytes before transmission and is about 3 bytes after transmission.

FIG. 13 is a graph illustrating the maximum number of modules included in a DII message, based on experimental results. In the experiment, the maximum number of modules included in the DII message is measured in relation to each stream. The measurements use the content size in the DII message and average sizes of URI descriptors and content-type descriptors, on an assumption that one DII message consists of a 4096-byte section. The X-axis indicates streams and the Y-axis indicates the maximum numbers of modules included in a DII message. The value marked above each bar graph pair shown in FIG. 13 indicates a module number ratio representing after to before measurements of sending module information using the transmission method according to an illustrative embodiment of the present invention. FIG. 13 reveals that the maximum number of modules included in a DII message doubles after sending the module information using the transmission method. Let us compare an ideal number of modules included in a DII message to the actual number of modules included in the module group of a stream. When transmitting module information without performing the method, it is possible to insert all modules into a DII message in only the fifth stream. However, after using the transmission method, all streams, except the third, support all modules within a single DII message. Therefore, the third stream with a one-layer structure needs to change to a two-layer structure where the modules are divided into two parts and included in two DII messages.

As described above, in a method of transmitting module information using DSI and DII messages according to an illustrative embodiment of the present invention, space is saved in the DII message through the use of information regarding application resources, i.e., URI information or content-type information. Information that is shared by the application resources is contained in a DSI message and the remaining information, not shared by the application resources, is included in a DII message. Accordingly, it is possible to effectively transmit module information by inserting more modules into each DII message.

This invention has been particularly shown and described with reference to illustrative embodiments thereof, and it will be understood by those skilled in the art that various changes in form and details may be made therein without departing from the spirit and scope of the invention as defined by the appended claims.

What is claimed is:

1. A method of transmitting module information, representing application resources, in a DASE data broadcasting system using a data carousel protocol, the method comprising:
inserting shared uniform resource identifier (URI) information into a DownloadServerInitiate (DSI) message that provides information regarding a module group, the module group having a predetermined number of modules and the shared URI information being shared by a plurality of modules belonging to the module group; and
inserting remaining URI information, excluding the shared URI information, into a DownloadInfoIndication (DII) message that provides the module information.

2. The method of claim 1, wherein the shared URI information is inserted as a descriptor into a field groupInfoByte of a structure GroupInfoIndication() in the DSI message.

3. The method of claim 1, wherein the remaining URI information is inserted as a descriptor into a structure descriptor() of the DII message.

4. A method of transmitting module information, representing application resources, in a DASE broadcasting system using a data carousel protocol, the method comprising:
inserting shared content-type information into a DSI message that provides information regarding a module group, the module group having a predetermined number of modules and the shared content-type information being shared by a plurality of modules belonging to the module group; and
inserting other content-type information, different from the shared content-type information, into a DII message that provides the module information.

5. The method of claim 4, wherein during insertion of the other content-type information, only the other content-type information regarding modules, which is not shared by the modules belonging to the module group, is included in the DII message.

6. The method of claim 4, wherein the shared content-type information corresponds to a content type that is most frequently shared by the modules of the module group.

7. The method of claim 4, wherein the shared content-type information is inserted as a descriptor into a field groupInfoByte of a structure GroupInfoIndication() in the DSI message.

8. The method of claim 4, wherein the other content-type information is inserted as a descriptor into a structure descriptor() of the DII message.

9. The method of claim 4, wherein a structure descriptor() of the DII message, for each module of the module group that shares the shared content-type information, is left blank.

10. An apparatus for transmitting module information representing application resources in a DASE data broadcasting system using a data carousel protocol, the apparatus comprising:
a message creator that creates a DSI message and a DII message, the DSI message providing information regarding module groups and containing shared URI information shared by a plurality of modules belonging to the module groups, each module group having a predetermined number of modules, and the DII message providing module information and containing the remaining URI information, excluding the shared URI information; and
a message sender that sends the created messages.

11. The apparatus of claim 10, wherein the shared URI information is inserted as a descriptor into a field groupInfoByte of a structure GroupInfoIndication in the DSI message.

12. The apparatus of claim 10, wherein the remaining URI information is inserted as a descriptor into a structure descriptor() of the DII message.

13. An apparatus for transmitting module information representing application resources in a DASE data broadcasting system using a data carousel protocol, the apparatus comprising:
a message creator that creates a DSI message and a DII message, the DSI message providing information regarding module groups and containing shared content-type information shared by a plurality of modules belonging to the module groups, each module group having a predetermined number of modules, and the DII message providing module information and containing other content-type information different from the shared content-type information; and
a message sender that sends the created messages.

14. The apparatus of claim 13, wherein the shared content-type information corresponds to a content type that is most frequently shared by the modules of a module group.

15. The apparatus of claim 13, wherein the shared content-type information is inserted as a descriptor into a field groupInfoByte of a structure GroupInfoIndication() in the DSI message.

16. The apparatus of claim 13, wherein the other content-type information is inserted as a descriptor into a structure descriptors of the DII message.

17. The apparatus of claim 13, wherein a structure descriptor() of the DII message, for each module of a module group that shares the shared content-type information, is left blank.
